(19) United States
(12) Patent Application Publication
(10) Pub. No.: US 2022/0237692 A1
(43) Pub. Date: Jul. 28, 2022

(54) METHOD AND SYSTEM FOR PROVIDING FINANCIAL PROCESS AUTOMATION TO FINANCIAL ORGANIZATION

(71) Applicant: Signzy Technologies Private Limited, Mumbai (IN)

(72) Inventors: Ankit RATAN, Mumbai (IN); Arpit RATAN, Mumbai (IN); Ankur PANDEY, Mumbai (IN)

(73) Assignee: Signzy Technologies Private Limited, Mumbai (IN)

(21) Appl. No.: 17/649,161

(22) Filed: Jan. 27, 2022

(30) Foreign Application Priority Data
Jan. 28, 2021 (IN) 202121003875

(51) Int. Cl. G06Q 40/02; G06N 20/00

(52) U.S. Cl. CPC G06Q 40/02; G06N 20/00

(57) ABSTRACT

The present disclosure provides a financial process automation system, which performs a method for providing robotic process automation for a financial organization. The method focuses on receiving one or more user documents associated with a user. The one or more user documents are identification documents associated with the user. In addition, the method focuses on classifying each of the one or more user documents in a set of documents. The financial process automation system classifies each of the one or more user documents based on type of financial service requested by the financial organization. Further, the method focuses on detecting one or more form fields in each of the one or more user documents. Furthermore, the method focuses on performing training of the financial process automation system. Moreover, the method focuses on creating custom implementation of the financial process automation system.

### TECHNICAL FIELD

The present invention relates to the technical field of document processing, and in particular, provides a method and system for enabling a financial organization to automate processing of user documents.

### INTRODUCTION

Over the last few years, there has been a significant rise in number of documents that have to be reviewed, processed, stored and transformed into computer-readable data. For an example, documents include financial statements, collections, legal papers, insurance claims, account forms, confidential data, mortgages, tax forms, and so on. Generally, these documents contain data that has to be extracted in order to be further processed. Data contains information about a user. The user makes an account on a system associated with an organization. The user manually enters information, such as name, address, contact number, date of birth, gender, and so on. In addition, the user may upload images of identification documents, image of the user, signature and so on. Conventionally, information of the user is extracted by an administrator manually from forms. However, manual data extraction is clerical in nature and time consuming. Further, manual data extraction is tedious and expensive.

### SUMMARY

In first example, a computer-implemented method is provided. The computer-implemented method provides robotic process automation for a financial organization. The computer-implemented method includes a first step of receiving one or more user documents associated with a user. The computer-implemented method includes a second step of classifying each of the one or more user documents in a set of documents. The computer-implemented method includes a third step of detecting one or more form fields in each of the one or more user documents. The computer-implemented method includes a fourth step of performing training of the financial process automation system. The computer-implemented method includes a fifth step of creating custom implementation of the financial process automation system. The one or more user documents are identification documents associated with the user. The one or more user documents are received from one or more sources. The one or more user documents are received in one or more input formats. The financial process automation system classifies each of the one or more user documents in the set of documents based on a confidence score of each of the one or more user documents. The financial process automation system classifies each of the one or more user documents based on type of financial service requested by the financial organization. The one or more form fields are detected using one or more hardware-run algorithms. The one or more form fields are detected for extracting information of the user from the one or more user documents. The training of the financial process automation system is performed using an artificial intelligence decision engine. The training of the financial process automation system is performed until accuracy of the financial process automation system is above a predefined threshold value. The custom implementation of the financial process automation system is created in real-time. The custom implementation of the financial process automation system is created based on type of financial service requested by the financial organization.

In an embodiment of the present disclosure, the one or more user documents comprises at least one of proof of residence of the user, proof of identity of the user, proof of age of the user, photograph of the user, signature of the user, permanent account number of the user, education certificate of the user, character certificate of the user, national identity document of the user, and income certificate of the user.

In an embodiment of the present disclosure, each of the set of documents comprises at least one of passport of the user, birth certificate of the user, driving license of the user, social security card of the user, society welfare card of the user, income tax card of the user, voter ID card of the user, electricity bill of the user, water consumption bill of the user, gas consumption bill of the user, rent agreement of the user, credit card bill of the user, and telephone bill of the user.

In an embodiment of the present disclosure, the one or more input formats comprises at least one of text, image, audio, video, gif, and animation.

In an embodiment of the present disclosure, the one or more sources comprises at least one of manual forms filled by the user, web-based forms, mobile application based forms, and data from third-party offline and online sources.

In an embodiment of the present disclosure, the financial process automation system provides an interface to a client for interacting with the financial process automation system using a virtual assistant, the virtual assistant provides complete assistance to the client for enabling the custom implementation of the financial process automation system.

In an embodiment of the present disclosure, the financial process automation system performs facial image extraction from the one or more user documents, the financial process automation system performs the facial image extraction with facilitation of the artificial intelligence decision engine, the financial process automation system performs the facial image extraction using one or more computer vision algorithms.

In an embodiment of the present disclosure, the computer-implemented method further comprising performing signature extraction, for extracting signature from the one or more user documents, the financial process automation system performs signature extraction using one or more feature detection algorithms.

In an embodiment of the present disclosure, the computer-implemented method further comprising masking sensitive information extracted from the one or more user documents, the financial process automation system performs the masking using one or more masking algorithms, the financial process automation system performs the masking for securing sensitive information present in the one or more user documents.

In an embodiment of the present disclosure, the computer-implemented method further comprising calculating the confidence score using the artificial intelligence decision engine, the confidence score facilitates in determining the set of documents to be requested from the user based on the type of financial service provided by the financial process automation system, the financial process automation system re-calculates the confidence score based on re-training of the financial process automation system.

In second example, a computer system is provided. The computer system includes one or more processors and a memory coupled to the one or more processors. The memory stores instructions. The instructions are executed by the one or more processors. The execution of instruction enables the one or more processors to perform a method for providing robotic process automation for a financial organization. The method includes a first step of receiving one or more user documents associated with a user. In addition, the method includes a second step of classifying each of the one or more user documents in a set of documents. Further, the method includes a third step of detecting one or more form fields in each of the one or more user documents. Furthermore, the method includes a fourth step of performing training of the financial process automation system. Moreover, the method includes a fifth step of creating custom implementation of the financial process automation system. The one or more user documents are identification documents associated with the user. The one or more user documents are received from one or more sources. The one or more user documents are received in one or more input formats. The financial process automation system classifies each of the one or more user documents in the set of documents based on a confidence score of each of the one or more user documents. The financial process automation system classifies each of the one or more user documents based on type of financial service requested by the financial organization. The one or more form fields are detected using one or more hardware-run algorithms. The one or more form fields are detected for extracting information of the user from the one or more user documents. The training of the financial process automation system is performed using an artificial intelligence decision engine. The training of the financial process automation system is performed until accuracy of the financial process automation system is above a predefined threshold value. The custom implementation of the financial process automation system is created in real-time. The custom implementation of the financial process automation system is created based on type of financial service requested by the financial organization.

In an embodiment of the present disclosure, the one or more user documents comprises at least one of proof of residence of the user, proof of identity of the user, proof of age of the user, photograph of the user, signature of the user, permanent account number of the user, education certificate of the user, character certificate of the user, national identity document of the user, and income certificate of the user.

In an embodiment of the present disclosure, each of the set of documents comprises at least one of passport of the user, birth certificate of the user, driving license of the user, social security card of the user, society welfare card of the user, income tax card of the user, voter ID card of the user, electricity bill of the user, water consumption bill of the user, gas consumption bill of the user, rent agreement of the user, credit card bill of the user, and telephone bill of the user.

In an embodiment of the present disclosure, the one or more input formats comprises at least one of text, image, audio, video, gif, and animation.

In an embodiment of the present disclosure, the one or more sources comprises at least one of manual forms filled by the user, web-based forms, mobile application based forms, and data from third-party offline and online sources.

In an embodiment of the present disclosure, the financial process automation system provides an interface to a client for interacting with the financial process automation system using a virtual assistant, the virtual assistant provides complete assistance to the client for enabling the custom implementation of the financial process automation system.

In third example, a non-transitory computer-readable storage medium is provided. The non-transitory computer-readable storage medium encodes computer executable instructions that, when executed by at least one processor, performs a method for real-time prediction of one or more aspects associated with a fashion retailer for providing robotic process automation for a financial organization. The method includes a first step of receiving one or more user documents associated with a user. In addition, the method includes a second step of classifying each of the one or more user documents in a set of documents. Further, the method includes a third step of detecting one or more form fields in each of the one or more user documents. Furthermore, the method includes a fourth step of performing training of the financial process automation system. Moreover, the method includes a fifth step of creating custom implementation of the financial process automation system. The one or more user documents are identification documents associated with the user. The one or more user documents are received from one or more sources. The one or more user documents are received in one or more input formats. The financial process automation system classifies each of the one or more user documents in the set of documents based on a confidence score of each of the one or more user documents. The financial process automation system classifies each of the one or more user documents based on type of financial service requested by the financial organization. The one or more form fields are detected using one or more hardware-run algorithms. The one or more form fields are detected for extracting information of the user from the one or more user documents. The training of the financial process automation system is performed using an artificial intelligence decision engine. The training of the financial process automation system is performed until accuracy of the financial process automation system is above a predefined threshold value. The custom implementation of the financial process automation system is created in real-time. The custom implementation of the financial process automation system is created based on type of financial service requested by the financial organization.

In an embodiment of the present disclosure, the financial process automation system performs facial image extraction from the one or more user documents, the financial process automation system performs the facial image extraction with facilitation of the artificial intelligence decision engine, the financial process automation system performs the facial image extraction using one or more computer vision algorithms.

In an embodiment of the present disclosure, the computer-implemented method further comprising performing signature extraction, for extracting signature from the one or more user documents, the financial process automation system performs signature extraction using one or more feature detection algorithms.

In an embodiment of the present disclosure, the computer-implemented method further comprising masking sensitive information extracted from the one or more user documents, the financial process automation system performs the masking using one or more masking algorithms, the financial process automation system performs the masking for securing sensitive information present in the one or more user documents.

### BRIEF DESCRIPTION OF THE DRAWINGS

Having thus described the invention in general terms, reference will now be made to the accompanying drawings, which are not necessarily drawn to scale, and wherein:

FIG. 1 illustrates an interactive computing environment for providing robotic process automation for a financial organization, in accordance with various embodiments of the inventions; and

FIG. 2 illustrates a block diagram of a computing device, in accordance with various embodiments of the inventions.

FIG. 3 illustrates a block diagram of a communication device, in accordance with various embodiments of the inventions.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

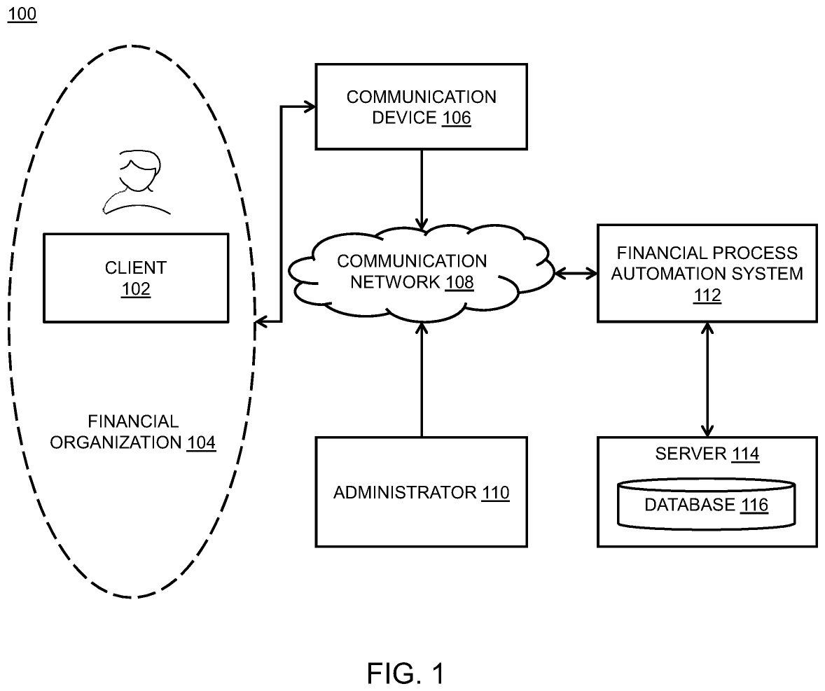

FIG. 1 illustrates an interactive computing environment 100 for providing robotic process automation for a financial organization 104, in accordance with various embodiments of the present disclosure. The interactive computing environment 100 includes a client 102, a communication device 106, a communication network 108 and a financial process automation system 112. In addition, the interactive computing environment 100 includes an administrator 110, a server 110 and a database 112.

The client 102 is any person that wants to access one or more services offered by the financial organization 104. In an embodiment of the present disclosure, the client 102 is any organization that wants to access one or more services of the financial organization 104. In an example, the one or more services include onboarding of a user, opening a new savings account of the user, opening a new current account of the user, application for home loan, business loan, or any type of loan, opening a demat account and the like.

In an embodiment of the present disclosure, the client 102 programs and trains the financial process automation system 112 to train an artificial intelligence decision engine. In another embodiment of the present disclosure, the administrator 110 programs and trains the financial process automation system 112 to train the artificial intelligence decision engine. In addition, the artificial intelligence decision engine facilitates automation and understanding of financial processes related to the financial organization 104. In general, artificial intelligence based decision engine is a mathematical algorithm trained using data and human expert input to replicate a decision an expert makes when provided with the same information.

The client 102 is any person that is associated with the financial organization 104. In an embodiment of the present disclosure, the client 102 personally visits the financial organization 104. In another embodiment of the present disclosure, the client 102 connects with the financial organization 104 using web-based application. In yet another embodiment of the present disclosure, the client 102 connects with the financial organization 104 using mobile based application. In yet another embodiment of the present disclosure, the client 102 connects with the financial organization 104 using desktop application. In yet another embodiment of the present disclosure, the client 102 connects with the financial organization 104 using any other application of the like.

The financial organization 104 is any organization that provides financial services to a user. In an embodiment of the present disclosure, the financial organization 104 includes one or more banks. In another embodiment of the present disclosure, the financial organization 104 includes one or more non-banking financial corporations. In yet another embodiment of the present disclosure, the financial organization 104 includes similar companies providing financial services to the user.

The communication device 106 is associated with the client 102. The client 102 utilizes the communication device 106 to connect to the financial process automation system 112. In an embodiment of the present disclosure, the communication device 106 is any smart device that mainly includes a display, camera and network connectivity. In an embodiment of the present disclosure, the communication device 106 is a portable communication device. In an example, the portable communication device includes laptop, smart phone, tablet, smart watch, and the like. In another embodiment of the present disclosure, the communication device 106 is a fixed communication device. In an example, the fixed communication device includes a desktop, a workstation PC and the like.

The communication device 106 performs computing operations based on a suitable operating system installed inside the communication device 106. In general, operating system is system software that manages computer hardware and software resources and provides common services for computer programs. In addition, the operating system acts as an interface for software installed inside the communication device 106 to interact with hardware components of the communication device 106.

In an embodiment of the present disclosure, the operating system installed inside the communication device 106 is a mobile operating system. In an embodiment of the present disclosure, the communication device 106 performs computing operations based on any suitable operating system designed for portable communication device. In an example, the mobile operating system includes but may not be limited to Windows operating system from Microsoft, Android operating system from Google, iOS operating system from Apple, Symbian operating system from Nokia, Bada operating system from Samsung Electronics and BlackBerry operating system from BlackBerry. However, the operating system is not limited to above mentioned operating systems. In an embodiment of the present disclosure, the communication device 106 operates on any version of particular operating system of above mentioned operating systems.

In another embodiment of the present disclosure, the communication device 106 performs computing operations based on any suitable operating system designed for fixed communication device. In an example, the operating system installed inside the communication device 106 is Windows from Microsoft. In another example, the operating system installed inside the communication device 106 is macOS from Apple. In yet another example, the operating system installed inside the communication device 106 is Linux based operating system. In yet another example, the operating system installed inside the communication device 106 may be one of UNIX, Kali Linux, and the like. However, the operating system is not limited to above mentioned operating systems. In an embodiment of the present disclosure, the communication device 106 operates on any version of particular operating system of above mentioned operating systems.

The communication device 106 of the client 102 connects to the financial process automation system 112 through the communication network 108. In addition, the communication network 108 is a part of network layer responsible for connection of the communication device 106 to the financial process automation system 112. Further, the communication network 108 may be any type of network. In an embodiment of the present disclosure, type of the communication network 108 is a wireless mobile network. In another embodiment of the present disclosure, type of the communication network 108 is a wired network with a finite bandwidth. In yet another embodiment of the present disclosure, type of the communication network 108 is a combination of the wireless and the wired network for the optimum throughput of data transmission. In yet another embodiment of the present disclosure, type of the communication network 108 is an optical fiber high bandwidth network that enables a high data rate with negligible connection drops.

Furthermore, the communication network 108 includes a set of channels. Moreover, each channel of the set of channels supports a finite bandwidth. The finite bandwidth of each channel of the set of channels is based on capacity of the communication network 108. Also, the communication device 106 possesses a unique machine address (hereinafter “MAC”). MAC uniquely identifies each of the communication device 106 over the communication network 108.

The administrator 110 is any person that is associated with the financial process automation system 112. In an example, the administrator 110 is a person that operates the financial process automation system 112. In another example, the administrator 110 is any person responsible for upkeep and maintenance of the financial process automation system 112. In yet another example, the administrator 110 is any person capable to troubleshoot the financial process automation system 112 in case of any errors or bugs.

In an embodiment of the present disclosure, the client 102 trains the artificial intelligence decision engine using one or more hardware run algorithms. The one or more hardware run algorithms includes machine learning algorithms, artificial intelligence algorithms, deep learning algorithms and the like. In an embodiment of the present disclosure, the client 102 is present inside the financial organization 104. In another embodiment of the present disclosure, the client 102 is located remotely from the financial organization 104.

The financial process automation system 112 performs a method to provide robotic process automation to the financial organization 104. The financial process automation system 112 provides robotic process automation to the financial organization 104 in real-time.

The financial process automation system 112 receives one or more user documents associated with the user. In an embodiment of the present disclosure, the client 102 uploads the one or more user documents of the user on the financial process automation system 112 for detection and extraction of user information. In another embodiment of the present disclosure, the administrator 110 uploads the one or more user documents of the user on the financial process automation system 112 for detection and extraction of user information. In yet another embodiment of the present disclosure, the user scans the one or more user documents using a scanner.

In general, scanner is an electronic device. In addition, scanner uses light-sensing equipment to scan paper image (say, text, photos, and illustrations) and translates the paper image into digital image. In an example, scanner is a physical scanner. Further, physical scanner scans the one or more user documents and converts the one or more user documents into digital images of one or more user documents. Furthermore, physical scanner operates by shining light at the one or more user documents and directing the reflected light onto a photosensitive element. Moreover, sensing medium in scanner is an electronic, light-sensing integrated circuit.

In another example, scanner is a single or multiple camera mobile equipment. In general, single or multiple camera mobile equipment includes one or more cameras on any face of the mobile equipment. In addition, the single or multiple camera mobile equipment captures images of the one or more user documents in the form of two dimensional images. Further, the two dimensional images may be processed in the mobile equipment itself or may be uploaded on cloud infrastructure for processing. In an example, the single or multiple camera mobile equipment includes smartphones, pocket cameras, hand cameras, DSLRs, portable computer cameras and the like.

In an embodiment of the present disclosure, the administrator 110 uploads the one or more user documents on the financial process automation system 112 through web-based application. In another embodiment of the present disclosure, the administrator 110 uploads the one or more user documents on the financial process automation system 112 through mobile based application. In yet another embodiment of the present disclosure, the administrator 110 uploads the one or more user documents on the financial process automation system 112 by scanning the one or more user documents using the scanner. In yet another embodiment of the present disclosure, the financial process automation system 112 fetches the one or more user documents from third party offline and online sources.

The one or more user documents are identification documents associated with the user. The financial process automation system 112 receives the one or more user documents from one or more sources. The one or more sources includes at least one of manual forms filled by the user, web-based forms, mobile application based forms, data from third-party offline and online sources, and the like. In addition, the financial process automation system 112 receives the one or more user documents in one or more input formats. The one or more input formats include but may not be limited to at least one of text, image, audio, video, gif, and animation.

The financial process automation system 112 receives the one or more user documents associated with the user. In an embodiment of the present disclosure, the financial process automation system 112 receives the one or more user documents through a computing device of the administrator 110. The computing device of the administrator 110 is identical to the communication device 106 of the client 102.

The one or more user documents includes at least one of proof of residence of the user, proof of identity of the user, proof of age of the user, photograph of the user, signature of the user, permanent account number of the user, education certificate of the user, character certificate of the user, national identity document of the user, income certificate of the user, and the like.

The financial process automation system 112 classifies each of the one or more user documents in a set of documents. The financial process automation system 112 classifies each of the one or more user documents in the set of documents based on a confidence score of each of the one or more user documents. The confidence score uses a convolutional neural network (CNN) to classify the images of the documents. The CNN provides a confidence score corresponding to each of the classes for a provided input image. The classifier selects the class with highest confidence score as the final classification output. Further, the financial process automation system 112 classifies each of the one or more user documents based on type of financial service requested by the financial organization 104.

Furthermore, each of the set of documents includes at least one of passport of the user, birth certificate of the user, driving license of the user, social security card of the user, society welfare card of the user, income tax card of the user, voter ID card of the user, electricity bill of the user, water consumption bill of the user, gas consumption bill of the user, rent agreement of the user, telephone bill of the user, credit card bill of the user, and the like.

In an embodiment of the present disclosure, the set of documents include one or more government identification documents, one or more address verification documents, and the like. In an example, the one or more government identification documents includes passport of the user, birth certificate of the user, and driving license of the user. In addition, the one or more government identification documents of the user includes social security card of the user, society welfare card of the user, income tax card of the user, voter ID card of the user, and the like. In another example, the one or more address verification documents include electricity bill of the user, water consumption bill of the user, gas consumption bill of the user, rent agreement of the user, telephone bill of the user, credit card bill of the user, and the like.

The financial process automation system 112 detects one or more form fields in each of the one or more user documents. The financial process automation system 112 detects the one or more form fields using one or more hardware-run algorithms. A first step of field detection includes receiving text output from the input images through optical character recognition (OCR). An output of the first step is passed into a post processor stage.

The post processor stage uses localization and content based filtering rules in order to correctly label each of the named entities. A final text remaining after the filtration is assigned to the label and is considered the output for that particular label (field). In an example, the financial process automation system 112 detects the one or more form fields using natural language processing algorithms. Moreover, the financial process automation system 112 detects the one or more form fields to extract information of the user from the one or more user documents.

In an embodiment of the present disclosure, the financial process automation system 112 uses optical character recognition technique to extract information of the user from the one or more user documents. In general, optical character recognition is electronic or mechanical conversion of images of typed, handwritten or printed text into machine-encoded text, whether from a scanned document, a photo of a document, a scene-photo or from subtitle text superimposed on an image.

In an example, information of the user includes name of the user in the one or more user documents. In another example, information of the user includes social security number of the user. In yet another example, information of the user includes one or more images of the user present in the one or more user documents. In yet another example, information of the user includes address of the user.

In an embodiment of the present disclosure, the financial process automation system 112 performs one or more artificial intelligence based checks using image forensics. In general, image forensics aims at validating authenticity of images by recovering information about history or past (such as identification of imaging device that captured image, detection of traces of forgeries, and the like) of images. In an embodiment of the present disclosure, the one or more artificial intelligence based checks involve facial image extraction, signature extraction, and masking of sensitive information from the one or more user documents.

The financial process automation system 112 performs facial image extraction from the one or more user documents. The financial process automation system 112 performs the facial image extraction with facilitation of the artificial intelligence decision engine. The financial process automation system 112 performs the facial image extraction using one or more computer vision algorithms.

The financial process automation system 112 performs signature extraction to extract signature from the one or more user documents. The financial process automation system 112 performs signature extraction using one or more feature detection algorithms. The financial process automation system 112 performs signature extraction in real-time.

The financial process automation system 112 masks sensitive information on the one or more user documents. The financial process automation system 112 performs the masking using one or more masking algorithms. The financial process automation system 112 performs the masking to secure sensitive information present in the one or more user documents.

The financial process automation system 112 is trained using the artificial intelligence decision engine. In an embodiment of the present disclosure, the client 102 performs training of the financial process automation system 112. In an embodiment of the present disclosure, the financial process automation system 112 is trained using the stored one or more user documents in the database. The financial process automation system 112 is trained until accuracy of the financial process automation system 112 is above a predefined threshold value.

In an embodiment of the present disclosure, the client 102 performs the training of the financial process automation system 112 based on requirement of the financial organization 104. In an example, the client 102 performs the training of the financial process automation system 112 using the one or more user documents until accuracy of the financial process automation system 112 is above the predefined threshold value based on requirement of the financial organization 104. The threshold value for any of label detection, field detection, forgery detection, liveliness and other image/video related characteristics is determined by business requirement and the business use case. The threshold value is chosen through a tradeoff analysis over the precision and recall that are deemed to be adequate to solve the defined use case.

In another embodiment of the present disclosure, the administrator 110 performs the training of the financial process automation system 112 based on requirement of the financial organization 104. In another example, the administrator 110 performs the training of the financial process automation system 112 using the one or more user documents until accuracy of the financial process automation system 112 is above the predefined threshold value based on requirement of the financial organization 104.

In an embodiment of the present disclosure, value of the predefined threshold varies based on requirement of the financial organization 104. In an embodiment of the present disclosure, the client 102 defines value of the predefined threshold based on requirement of the financial organization 104. In another embodiment of the present disclosure, the financial process automation system 112 defines value of the predefined threshold based on requirement of the financial organization 104. In yet another embodiment of the present disclosure, the administrator 110 defines value of the predefined threshold based on requirement of the financial organization 104.

The financial process automation system 112 creates custom implementation of the financial process automation system 112. The financial process automation system 112 creates the custom implementation of the financial process automation system 112 in real-time. The financial process automation system 112 creates the custom implementation of the financial process automation system 112 based on type of financial service requested by the financial organization 104.

In an embodiment of the present disclosure, custom implementation of the financial process automation system 112 is created on the computing device of the administrator 110. In an embodiment of the present disclosure, the administrator 110 is an owner of the computing device. In another embodiment of the present disclosure, the administrator 110 is not an owner of the computing device. In yet another embodiment of the present disclosure, the administrator 110 utilizes the computing device to access the financial process automation system 112.

The financial process automation system 112 calculates the confidence score with facilitation of the artificial intelligence decision engine. The confidence score enables the financial process automation system 112 to determine the set of documents to be requested from the user based on the type of financial service provided by the financial process automation system 112. The financial process automation system 112 re-calculates the confidence score based on re-training of the financial process automation system 112. The financial process automation system 112 provides the financial service if value of the confidence score is above a predefined standard. In an embodiment of the present disclosure, the client 102 defines the predefined standard based on requirement of the type of financial service by the financial organization 104. In another embodiment of the present disclosure, the financial process automation system 112 defines the predefined standard based on requirement of the type of financial service by the financial organization 104.

In an example, the financial process automation system 112 calculates the confidence score of the set of documents based on the type of financial service requested by the financial organization 104. In an example, financial organization A has requirement to onboard users in the financial organization A. The financial process automation system 112 requires two set of documents for identity proof and address proof for its users based on requirement of the financial organization A. A first set of documents (identity proof) may include documents such as passport of the user, driving license of the user and the like. A second set of documents (address proof) may include electricity bill of the user, water consumption bill of the user, and the like.

The financial process automation system 112 calculates the confidence score based on verification of data in the set of documents. The financial process automation system 112 calculates the confidence score based on the one or more hardware run algorithms. In an example, the financial process automation system 112 calculates the confidence score as per verification of details of the user in all documents uploaded by the user. The confidence score increases after each successful check of information of the user in all documents uploaded by the user. The confidence score facilitates in performing onboarding of the user in the financial organization A.

In an example, the financial process automation system 112 performs onboarding of the user in the financial organization A only if the confidence score is above the predefined standard. In an embodiment of the present disclosure, the financial process automation system 112 performs a set of actions based on calculation of the confidence score. In an example, the set of actions include at least one of acceptance, on-hold or rejection of application of the user.

In an embodiment of the present disclosure, the financial process automation system 108 provides an interface to the client 102 to interact with the financial process automation system 108 using a virtual assistant. The virtual assistant provides complete assistance to the client 102 to create the custom implementation of the financial process automation system 108. The administrator 110 interacts with the financial process automation system 112 using the virtual assistant. In general, virtual assistant is an advanced computer program that simulates a conversation with people using it over the internet. Further, the virtual assistant uses advanced artificial intelligence, natural language processing, natural language understanding, and machine learning algorithms to learn and provide a personalized, conversational experience.

In an embodiment of the present disclosure, the communication device 106 of the administrator 110 connects with the financial process automation system 112 by utilizing one or more applications. The one or more applications include but may not be limited to web browser, mobile application, widget and web applet. In general, each of the one or more applications has a graphical user interface that is designed to display and fetch data from the server 110. Further, web browser installed in the communication device 106 of the user 110 may be any web browser. In an example, web browser includes Google Chrome, Mozilla Firefox, Opera, UC Web, Safari, Microsoft Edge, and the like. In addition, mobile application installed in the computing device may be based on any mobile platform. In an example, mobile platform includes but may not be limited to Android, iOS Mobile, Blackberry and Bada.

In an embodiment of the present disclosure, the financial process automation system 112 is installed at the server 110. In another embodiment of the present disclosure, the financial process automation system 112 is installed in the communication device 106. In yet another embodiment of the present disclosure, the financial process automation system 112 is installed in the computing device of the administrator 110. In yet another embodiment of the present disclosure, the financial process automation system 112 is installed in device of the user.

In an embodiment of the present disclosure, the one or more input formats include one or more multimedia formats. In an example, the user uploads the one or more user documents using the device. The device of the user is identical to the computing device of the administrator 110. In an example, the one or more multimedia formats include but may not be limited to TIFF, Bitmap, JPEG, GIF, PNG, EPS, RAW Image Files and PDF. In an example, the user scans driving license of the user using the device to upload at the financial process automation system 112. In another example, the user clicks picture of passport of the user. Further, the user uploads picture of passport at the financial process automation system 112 using the device.

The interactive computing environment 100 includes the server 110. The financial process automation system 112 is associated with the server 110. In general, server is a computer program that provides service to another computer programs. In addition, server may provide various functionalities or services, such as sharing data or resources among multiple administrators, performing computation for a administrator and the like. In an embodiment of the present disclosure, the server 110 is at least one of dedicated server, cloud server, network server, virtual private server and the like. However, the server 110 is not limited to above mentioned servers.

In addition, the server 110 includes the database 112. In general, database is a collection of information that is organized so that it can be easily accessed, managed and updated. In an embodiment of the present disclosure, the database 112 is at least one of at least hierarchical database, network database, relational database, object-oriented database and the like. The database 112 provides storage location to the one or more user documents, information of the user, information of the administrator 110 and data associated with the financial process automation system 112. In an embodiment of the present disclosure, the database 112 provides storage location to all the data and information required by the financial process automation system 112. In an example, the database 112 is connected to the server 110. The server 110 stores data in the database 112. The server 110 interacts with the database 112 to retrieve the stored data.

In an embodiment of the present disclosure, the financial process automation system 112 stores the one or more user documents, information of the user, and information of the administrator 110 in the database 112. The financial process automation system 112 performs storing in real-time. In an embodiment of the present disclosure, the financial process automation system 112 updates the one or more user documents, information of the user, and information of the administrator 110 in the database 112 associated with the financial process automation system 112. The financial process automation system 112 performs updating in real-time.

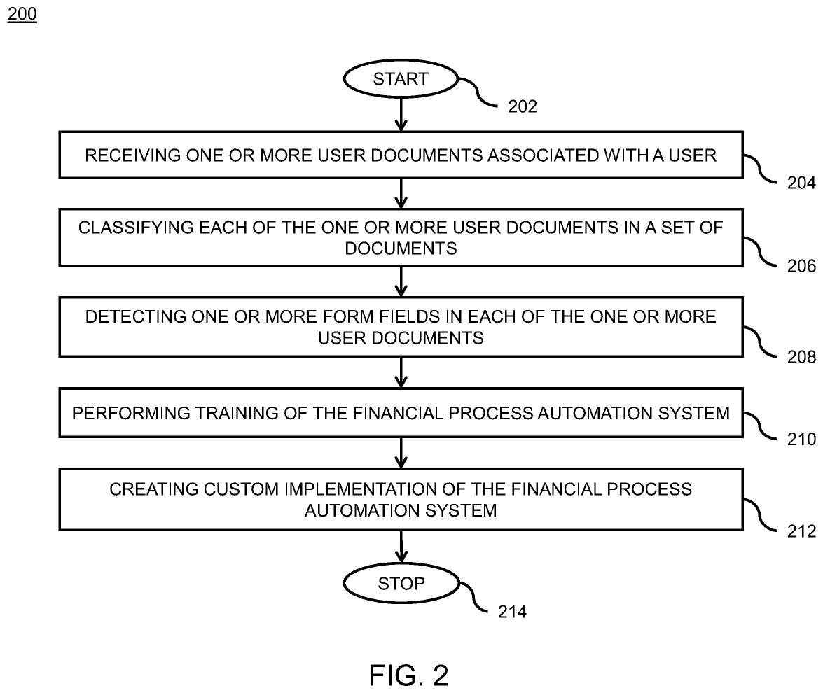

FIG. 2 illustrates a flowchart 200 of the method for providing robotic process automation for a financial organization, in accordance with various embodiments of the present disclosure. It may be noted that in order to explain the method steps of the flowchart 200, references will be made to the elements explained in FIG. 1. The flow chart 200 starts at step 202. At step 204, the financial process automation system 112 receives the one or more user documents associated with the user. At step 206, the financial process automation system 112 classifies each of the one or more user documents in the set of documents. At step 208, the financial process automation system 112 detects the one or more form fields in each of the one or more user documents. At step 210, the financial process automation system 112 performs training of the financial process automation system. At step 212, the financial process automation system 112 creating custom implementation of the financial process automation system.

The flowchart 200 terminates at step 214. It may be noted that the flowchart 200 is explained to have above stated process steps; however, those skilled in the art would appreciate that the flowchart 200 may have more/less number of process steps which may enable all the above stated embodiments of the present disclosure.

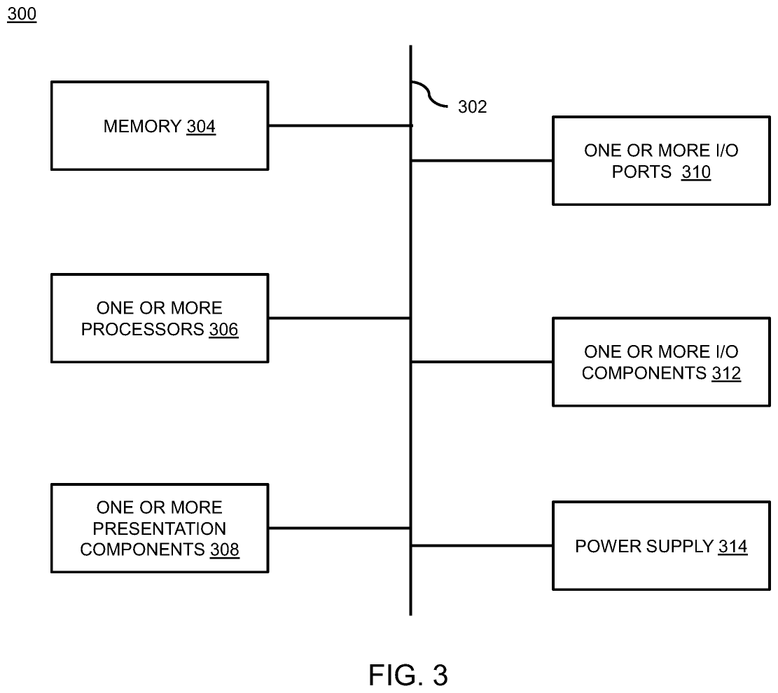

FIG. 3 illustrates a block diagram of a communication device 300, in accordance with various embodiments of the present disclosure. The communication device 300 represents internal hardware components of the communication device 106. The communication device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary communication device 300 that can be used in connection with one or more embodiments of the present invention. The distinction is not made between such categories as “workstation,” “server,” “laptop,” “hand-held device,” etc., as all are contemplated within the scope of FIG. 3 and reference to “communication device.”

The communication device 300 typically includes a variety of computer-readable media. The computer-readable media can be any available media that can be accessed by the communication device 300 and includes both volatile and nonvolatile media, removable and non-removable media. By way of example, and not limitation, the computer-readable media may comprise computer readable storage media and communication media. The computer readable storage media includes volatile and nonvolatile, removable and non-removable media implemented in any method or technology for storage of information such as computer-readable instructions, data structures, program modules or other data.

The computer-readable storage media with memory 304 includes, but is not limited to, non-transitory computer readable media that stores program code and/or data for longer periods of time such as secondary or persistent long term storage, like RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the communication device 300. The computer-readable storage media associated with the memory 304 and/or other computer-readable media described herein can be considered computer readable storage media for example, or a tangible storage device. The communication media typically embodies computer-readable instructions, data structures, program modules or other data in a modulated data signal such as a carrier wave or other transport mechanism and in such a includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. The communication device 300 includes one or more processors that read data from various entities such as the memory 304 or I/O components 312. The one or more presentation components 308 present data indications to a user or other device. Exemplary presentation components include a display device, speaker, printing component, vibrating component, etc. The one or more I/O ports 310 allow the communication device 300 to be logically coupled to other devices including the one or more I/O components 312, some of which may be built in. Illustrative components include a microphone, joystick, game pad, satellite dish, scanner, printer, wireless device, etc.

What is claimed:

1. A computer-implemented method for providing robotic process automation for a financial organization, the computer-implemented method comprising:
receiving, at a financial process automation system with a processor, one or more user documents associated with a user, wherein the one or more user documents are identification documents associated with the user, wherein the one or more user documents are received from one or more sources, wherein the one or more user documents are received in one or more input formats;
classifying, at the financial process automation system with the processor, each of the one or more user documents in a set of documents, wherein the financial process automation system classifies each of the one or more user documents in the set of documents based on a confidence score of each of the one or more user documents, wherein the financial process automation system classifies each of the one or more user documents based on type of financial service requested by the financial organization;
detecting, at the financial process automation system with the processor, one or more form fields in each of the one or more user documents, wherein the one or more form fields are detected using one or more hardware-run algorithms, wherein the one or more form fields are detected for extracting information of the user from the one or more user documents;
performing, at the financial process automation system with the processor, training of the financial process automation system, wherein the training of the financial process automation system is performed using an artificial intelligence decision engine, wherein the training of the financial process automation system is performed until accuracy of the financial process automation system is above a predefined threshold value; and
creating, at the financial process automation system with the processor, custom implementation of the financial process automation system, wherein the custom implementation of the financial process automation system is enabled in real-time, wherein the custom implementation of the financial process automation system is enabled based on the type of financial service requested by the financial organization.

2. The computer implemented method as claimed in claim 1, wherein the one or more user documents comprises at least one of proof of residence of the user, proof of identity of the user, proof of age of the user, photograph of the user, signature of the user, permanent account number of the user, education certificate of the user, character certificate of the user, national identity document of the user, and income certificate of the user.

3. The computer implemented method as claimed in claim 1, wherein each of the set of documents comprises at least one of passport of the user, birth certificate of the user, driving license of the user, social security card of the user, society welfare card of the user, income tax card of the user, voter ID card of the user, electricity bill of the user, water consumption bill of the user, gas consumption bill of the user, rent agreement of the user, credit card bill of the user, and telephone bill of the user.

4. The computer implemented method as claimed in claim 1, wherein the one or more input formats comprises at least one of text, image, audio, video, gif, and animation.

5. The computer implemented method as claimed in claim 1, wherein the one or more sources comprises at least one of manual forms filled by the user, web-based forms, mobile application based forms, and data from third-party offline and online sources.

6. The computer implemented method as claimed in claim 1, wherein the financial process automation system provides an interface to a client for interacting with the financial process automation system using a virtual assistant, wherein the virtual assistant provides complete assistance to the client for enabling the custom implementation of the financial process automation system.

7. The computer implemented method as claimed in claim 1, wherein the financial process automation system performs facial image extraction from the one or more user documents, wherein the financial process automation system performs the facial image extraction with facilitation of the artificial intelligence decision engine, wherein the financial process automation system performs the facial image extraction using one or more computer vision algorithms.

8. The computer implemented method as claimed in claim 1, further comprising performing signature extraction, at the financial process automation system with the processor, for extracting signature from the one or more user documents, wherein the financial process automation system performs signature extraction using one or more feature detection algorithms.

9. The computer implemented method as claimed in claim 1, further comprising masking, at the financial process automation system with the processor, sensitive information extracted from the one or more user documents, wherein the financial process automation system performs the masking using one or more masking algorithms, wherein the financial process automation system performs the masking for securing sensitive information present in the one or more user documents.

10. The computer implemented method as claimed in claim 1, further comprising calculating, at the financial process automation system with the processor, the confidence score using the artificial intelligence decision engine, wherein the confidence score facilitates in determining the set of documents to be requested from the user based on the type of financial service provided by the financial process automation system, wherein the financial process automation system re-calculates the confidence score based on re-training of the financial process automation system.

11. A computer system comprising:
one or more processors; and
a memory coupled to the one or more processors, the memory for storing instructions which, when executed by the one or more processors, cause the one or more processors to perform a method for providing robotic process automation for a financial organization, the method comprising:
receiving, at a financial process automation system, one or more user documents associated with a user, wherein the one or more user documents are identification documents associated with the user, wherein the one or more user documents are received from one or more sources, wherein the one or more user documents are received in one or more input formats;
classifying, at the financial process automation system, each of the one or more user documents in a set of documents, wherein the financial process automation system classifies each of the one or more user documents in the set of documents based on a confidence score of each of the one or more user documents, wherein the financial process automation system classifies each of the one or more user documents based on type of financial service requested by the financial organization;
detecting, at the financial process automation system, one or more form fields in each of the one or more user documents, wherein the one or more form fields are detected using one or more hardware-run algorithms, wherein the one or more form fields are detected for extracting information of the user from the one or more user documents;
performing, at the financial process automation system, training of the financial process automation system, wherein the training of the financial process automation system is performed using an artificial intelligence decision engine, wherein the training of the financial process automation system is performed until accuracy of the financial process automation system is above a predefined threshold value; and
creating, at the financial process automation system, custom implementation of the financial process automation system, wherein the custom implementation of the financial process automation system is enabled in real-time, wherein the custom implementation of the financial process automation system is enabled based on the type of financial service requested by the financial organization.

12. The computer system as claimed in claim 11, wherein the one or more user documents comprises at least one of proof of residence of the user, proof of identity of the user, proof of age of the user, photograph of the user, signature of the user, permanent account number of the user, education certificate of the user, character certificate of the user, national identity document of the user, and income certificate of the user.

13. The computer system as claimed in claim 11, wherein each of the set of documents comprises at least one of passport of the user, birth certificate of the user, driving license of the user, social security card of the user, society welfare card of the user, income tax card of the user, voter ID card of the user, electricity bill of the user, water consumption bill of the user, gas consumption bill of the user, rent agreement of the user, credit card bill of the user, and telephone bill of the user.

14. The computer system as claimed in claim 11, wherein the one or more input formats comprises at least one of text, image, audio, video, gif, and animation.

15. The computer system as claimed in claim 11, wherein the one or more sources comprises at least one of manual forms filled by the user, web-based forms, mobile application based forms, and data from third-party offline and online sources.

16. The computer system as claimed in claim 11, wherein the financial process automation system provides an interface to a client for interacting with the financial process automation system using a virtual assistant, wherein the virtual assistant provides complete assistance to the client for enabling the custom implementation of the financial process automation system.

17. A non-transitory computer-readable storage medium encoding computer executable instructions that, when executed by at least one processor, performs a method for providing robotic process automation for a financial organization, the method comprising:
receiving, at a computing device, one or more user documents associated with a user, wherein the one or more user documents are identification documents associated with the user, wherein the one or more user documents are received from one or more sources, wherein the one or more user documents are received in one or more input formats;
classifying, at the computing device, each of the one or more user documents in a set of documents, wherein the financial process automation system classifies each of the one or more user documents in the set of documents based on a confidence score of each of the one or more user documents, wherein the financial process automation system classifies each of the one or more user documents based on type of financial service requested by the financial organization;
detecting, at the computing device, one or more form fields in each of the one or more user documents, wherein the one or more form fields are detected using one or more hardware-run algorithms, wherein the one or more form fields are detected for extracting information of the user from the one or more user documents;
performing, at the computing device, training of the financial process automation system, wherein the training of the financial process automation system is performed using an artificial intelligence decision engine, wherein the training of the financial process automation system is performed until accuracy of the financial process automation system is above a predefined threshold value; and
creating, at the computing device, custom implementation of the financial process automation system, wherein the custom implementation of the financial process automation system is enabled in real-time, wherein the custom implementation of the financial process automation system is enabled based on the type of financial service requested by the financial organization.

18. The non-transitory computer-readable storage medium as claimed in claim 17, wherein the financial process automation system performs facial image extraction from the one or more user documents, wherein the financial process automation system performs the facial image extraction with facilitation of the artificial intelligence decision engine, wherein the financial process automation system performs the facial image extraction using one or more computer vision algorithms.

19. The non-transitory computer-readable storage medium as claimed in claim 17, further comprising performing signature extraction, at the financial process automation system, for extracting signature from the one or more user documents, wherein the financial process automation system performs signature extraction using one or more feature detection algorithms.

20. The non-transitory computer-readable storage medium as claimed in claim 17, further comprising masking, at the financial process automation system, sensitive information extracted from the one or more user documents, wherein the financial process automation system performs the masking using one or more masking algorithms, wherein the financial process automation system performs the masking for securing sensitive information present in the one or more user documents.
